(19) United States
(12) Patent Application Publication
(10) Pub. No.: US 2011/0155771 A1
(43) Pub. Date: Jun. 30, 2011

(54) METHOD AND APPARATUS FOR ENABLING SMOOTHER, FASTER DISCHARGE OF FLUID FROM CONTAINERS

(76) Inventor: Dennis L. Brooks, Aurora, CO (US)

(21) Appl. No.: 12/538,713

(22) Filed: Aug. 10, 2009

(51) Int. Cl. B67D 3/00

(52) U.S. Cl. 222/481

(57) ABSTRACT

The device disclosed herein relates to an automatic demand valve that allows for the rapid discharge of liquid from a bottle or container and which overcomes a glugging action and/or container collapse. The valve opens when pressure is placed thereon and closes when demand is alleviated.

### FIELD OF ART

The disclosed device and method relate generally to a valve that allows for the rapid discharge of fluid from a bottle or container, and more specifically to an automatic demand valve which opens when demand is placed on the valve and which overcomes a glugging action encountered and/or container collapse.

### BACKGROUND

It is common knowledge that a container that has a reduced area for an outlet will “glug” (the outgoing liquid will alternate with the incoming air) when it is tilted to remove the liquid contained therein. This is a nuisance and can be a hazard if toxic or flammable materials are involved. One solution has been to punch a hole in the bottom of the container away from the opening. This smoothes the flow nicely but there is a drawback. The container must be emptied all at once or the contents will exit through the hole. When a fluid is toxic or flammable, this can create a hazardous situation. In the case of larger bottles or containers, fluid head pressure may also be sufficient to cause resilient collapsing of the container as the fluid is discharged.

Thus, there is a need for a smoother discharge of fluids from a container or vessel. Although the disclosed device has relation to containers that are common in daily residential and household uses, it is contemplated that the disclosed device could be applicable to industrial, commercial, and agricultural uses.

There are a number of containers that incorporate a cap or lid with a second conduit to vent air into the container. In addition, there are a number of quick drain systems for engines, gas tanks, reservoirs, oil filters, etc. utilizing assisted and, more relevantly, non-assisted gravity drainage. Further, it is commonly known that providing a puncture in a container remote from the desired container opening creates an air entry passage, cf., can of beer, can of chicken broth, etc.

In addition, the Applicant is aware that a type of demand valve used in a diving regulator controls the supply of gas by opening to provide flow when a user inhales and shuts off when inhalation stops. In these devices, typically a diaphragm in the regulator operates when the diver lowers the pressure inside the chamber by trying to inhale, releasing low pressure gas (breathing gas at ambient pressure into the chamber allowing the diver to inhale. When inhalation stops, the diaphragm moves back, closing the valve. When the diver exhales, the exhalation causes another valve to open to allow the gas to escape to the water outside. Demand valves may also be present in other face mask apparatus such as resuscitators and simple respirators in hazardous materials operations (e.g., full face respirator).

It is believed however that none of the prior art systems referred above comprise an automatic demand valve that allows for the rapid discharge of fluid from a container or vessel, the valve comprising a small-diametered hollow vent with a flexible and/or compressible member to allow air to directly enter the container.

### SUMMARY OF THE DISCLOSURE

The disclosed device pertains to an automatic demand valve that allows for the smooth discharge of fluid from a bottle or container and which overcomes a glugging action and/or container collapse. The automatic demand valve provides an entry into the void space above the liquid (container head space). Specifically, the disclosed device comprises a small-diametered hollow vent tube with a connected flexible valve to allow air to directly enter the container head space. It is contemplated that the disclosed device be mounted on any surface having communication with said head space.

An object of the disclosed device provides a valve serving as a small diameter vent tube forming an air passageway between the pouring opening and a head space.

Another object of the disclosed device is the provision of a removable valve that may be reused.

Another object of the disclosed device is the provision of a vent tube or valve which is of small diameter and is integrally mounted in the outside of a wall of a vessel.

Another object of the disclosed device is the provision of a vent tube or valve which is integrally mounted in a vessel wall so as to direct air into the vessel.

Another object of the disclosed device is the provision of an adjustable valve having a compressible spring.

These and other advantages of the disclosed device will appear from the following description and/or appended claims, reference being made to the accompanying drawings that form a part of this specification wherein like reference characters designate corresponding parts in the several views.

### BRIEF DESCRIPTION OF THE DRAWINGS

FIG. 1 is a cutaway illustration of the disclosed device at rest in a normally closed position and installed in a vessel wall.

FIG. 2 depicts a perspective view of the device shown in FIG. 1.

FIG. 3 depicts an exploded view of the device shown in FIGS. 1, 2.

FIG. 4 is a cutaway illustration of an embodiment that has been integrated into a vessel wall.

FIG. 5 illustrates an embodiment having a compressible spring which is adjustable.

FIG. 6 illustrates an alternate embodiment of the device shown in FIG. 5.

FIG. 7A is a cutaway illustration of an alternate embodiment of the disclosed device at rest in a normally closed position and installable in a vessel wall.

FIG. 7B is an end view of the device shown in FIG. 7A.

FIG. 7C is a perspective view of the device shown in FIGS. 7A, 7B in an activated or open position.

FIG. 7D depicts the embodiment of FIGS. 7A-7C mounted in a wall of a container.

FIGS. 8A, 8B are a perspective view and an end view, respectively, of another embodiment of the disclosed device.

FIG. 8C is a cutaway illustration of the embodiment shown in FIGS. 8A, 8B.

FIG. 8D is a perspective view of a connecting member useful with the embodiment shown in FIGS. 8A, 8B, 8C.

FIG. 8E illustrates the disclosed device mounted in a container having a neck.

FIG. 9 depicts the disclosed device adaptable for use in an industrial application.

FIGS. 10A, 10B depict another embodiment of the disclosed device.

Before explaining the disclosed embodiments of the disclosed device in detail, it is to be understood that the device is not limited in its application to the details of the particular arrangements shown, since the device is capable of other embodiments. Also, the terminology used herein is for the purpose of description and not of limitation.

### DESCRIPTION OF THE DISCLOSED EMBODIMENT

The following description is provided to enable any person skilled in the art to make and use the disclosed apparatus. Various modifications, however, will remain readily apparent to those skilled in the art, since the generic principles of the present apparatus have been defined herein to provide for an automatic demand valve that allows for the smooth discharge of liquid from a container or a vessel.

The basic function of a check valve is to allow forward flow under normal conditions and prevent flow reversal. Presently, there exist many types of check valves or non-return valves designed to control the one-way flow of a fluid therethrough. The bodies or external shells of most check valves are made of plastic or metal. Check valves are two-port valves, meaning each has two openings in the valve body, one for fluid to enter and the other for fluid to exit. In short, fluid flows through the valve in only one direction. In this regard, the disclosed device resembles a check valve. However, the disclosed device differs from a typical check valve, i.e., diaphragm valve, ball check valve, etc. in several ways.

A diaphragm valve uses a flexing rubber diaphragm positioned to create a normally-closed valve. Pressure on the upstream (or inlet) side must be greater than the pressure on the downstream (or outlet) side by a certain amount, known as the pressure differential, for the diaphragm valve to open allowing flow. Once positive pressure stops, the diaphragm automatically flexes back to its original closed position.

In the example of a ball check valve, a ball serves to block the fluid flow. In some cases, the ball is spring loaded to help keep the valve shut. As pressure is exerted on the ball, the spring is compressed and the valve is opened. Once positive pressure stops, the ball is reseated in its original closed position. For designs that do not utilize a spring, reverse flow would be required to move the ball toward the seat and create a seal.

As stated above, the basic function of a check valve is to allow forward flow under normal conditions and avoid flow reversal. The disclosed device, however, functions as an “equalizer valve.” When pressure on the inlet end of the valve is greater than the pressure on the outlet end of the valve, a differential in pressure exists causing flow to the low pressure region. For example, if pressure at a point A (inlet side) is 5 psi and pressure at a point B (outlet side) is 4 psi, flow is from A to B until the pressure at point B approaches 5 psi. The slight difference in pressures at points A and B is the closing tension of the flexible portion of the valve. Under most conditions, pressure at point B will be equal or less than the pressure at point A. When carbonated beverages or other gas-generating liquids are on the B side of the valve (outlet), the B side can be at a higher pressure than the A side. This is also the case when the chamber the valve is located in is at a higher altitude and the A side is at a lower pressure.

Air enters the bottle through the valve instead of the mouth or neck portion to fill the space previously occupied by liquid to equalize the negative pressure induced by the passage of liquid from the bottle. The valve opens to allow air passage when lower pressure is produced within the container (when the container is canted) and closes when demand for air is alleviated. It is to be understood that the valves disclosed herein may be removed after use if desired and saved for later reuse. Alternately, the devices may take the form of a permanently mounted valve when justified by the application.

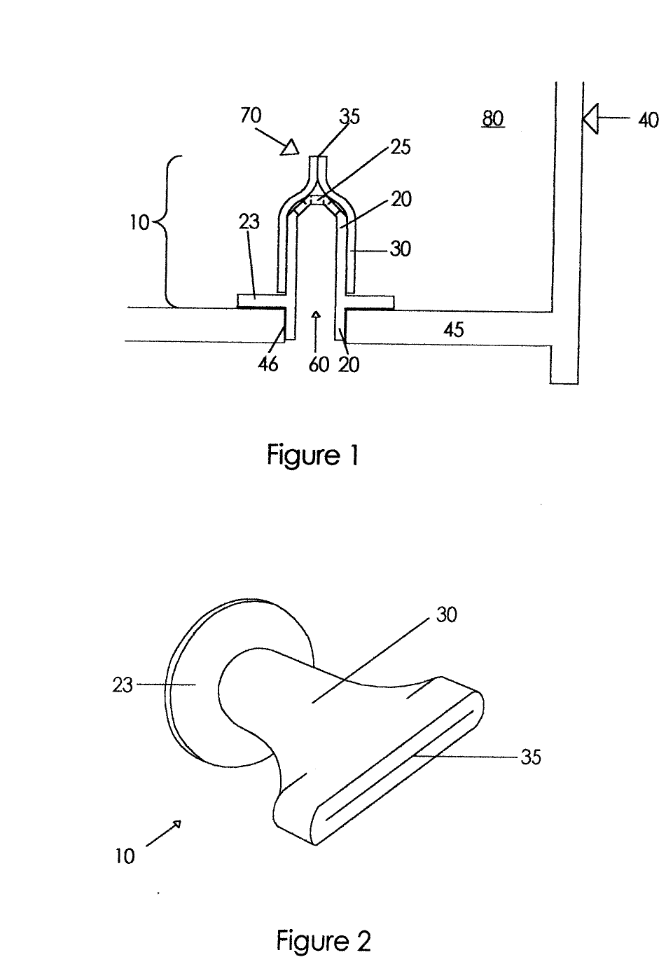

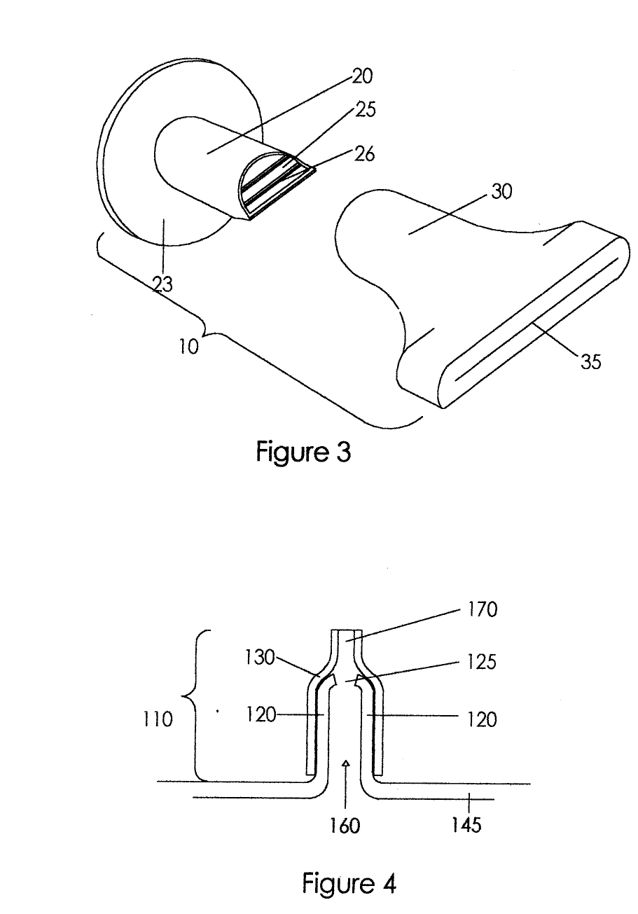

In the cutaway view of FIG. 1, valve 10 is shown positioned in an orifice 46 in a bottom wall 45 of a container or vessel 40. Valve 10 comprises a substantially rigid member 20 sheathed by a flexible member 30. Rigid member 20 comprises a flange 23 at one end and one or more apertures 25 at an opposite end. See also FIGS. 2, 3. In this example, apertures 25 are defined by one or more slim bars 26. Flexible member 30 comprises an aperture 35 that may be opened or closed as conditions dictate, i.e., “on demand.” In this embodiment, aperture 35 takes the form of a slot. Aperture 35 of flexible member 30 forms the outlet port 70 shown in FIG. 1.

In use, valve 10 should be positioned in wall 45 of vessel 40 in such a way that atmospheric air may be allowed to directly enter the vessel's head space 80 when demand is placed on the device. One having skill in the art will recognize that the valve could be installed in an end of a vessel or in an appropriate side wall depending on the orientation of the vessel and the fluid housed therein. However, as long as a pressure differential can be created, the valve may be positioned adjacent the vessel's head space or beneath the fluid level if suitable.

The disclosed device can be mounted in a hole or orifice 46 which pierces through a vessel wall. The inner diameter of the hole may be the approximate diameter of the outer diameter of the valve. To help ensure a close fit, the diameter of the hole could be designed to be smaller than the outer diameter of the valve if suitable. For example, a ¼″ diameter hole could be plugged with a valve having a rigid member with a diameter of slightly greater than ¼″. One having skill in the art would recognize that an orifice could be formed in an appropriate vessel by conventional methods and then retrofitted with a valve as disclosed herein. Seat members 21 may be mounted in orifice 46 such that flange 23 can closely abut an adjacent inner surface of the vessel. Thereafter, flexible member 30 could be mounted over rigid member 20.

Generally, a normally closed valve is defined as one in which the valving element is closed when de-energized (unactuated), preventing flow. When such a valve is actuated, the valving element is opened to allow flow. A normally open valve is thus defined as one in which the valving element is open when unactuated, allowing flow. When such a valve is actuated, the valving element closes to prevent flow.

It is contemplated that the valve 10 embodiment is a normally closed valve. Outlet port 70 is shown to be closed and flexible member 30 is at rest. By tipping the vessel 40 and thereby creating a pressure differential, aperture 35 of flexible member 30 opens. An opened aperture 35 would somewhat resemble an opening not unlike that which appears when pressing on the sides of a slotted coin purse. Air is drawn into valve 10 via inlet port 60 and out of valve 10 via apertures 25, 35 and outlet port 70. As air is drawn into head space 80 (or vessel 40 generally), a fluid (not shown) that is contained in vessel 40 can be discharged from the vessel via its top opening (not shown) in an expeditious manner with essentially no glugging.

To create the pressure differential, the vessel can simply be canted at a normal pouring angle that need not be overly inverted. The disclosed device would open to allow air inflow and thus acts as a “demand valve.” To stop the discharge of liquid, the outlet of the vessel is rotated above the liquid surface. Because the demand on the valve is alleviated, aperture 35 of flexible member 30 returns to its normally closed position, thereby preventing the flow of fluid through apertures 25.

As stated above, the disclosed device has relation to containers that are common in daily residential and household uses. Therefore, one having ordinary skill in the art would recognize that the materials of construction should meet requirements set by the U.S. Food & Drug Administration (FDA) for food-grade packaging if the use of the disclosed device contemplates the ingestion of a vessel's contents. It is also contemplated that the disclosed device could be used for vessels in industrial, commercial, and agricultural settings or anywhere where there is a need for smoother discharge of liquids. Non-food grade embodiments could be constructed from materials such as thermosetting plastics, e.g. phenolic resins, which remain permanently hard after being formed and cooled. Thermoplastics which remain flexible, e.g. high-density polyethylene (HDPE) and vinyl resins can also be used along with various elastomers. One having ordinary skill in the art would recognize that the materials of construction should meet regulatory and engineering requirements. In addition, the dimensions of the valves, valve components, housings, apertures are sizeable as needed.

In some cases, it may be desirable to manufacture a container or vessel having the disclosed valve mounted in place. FIG. 4 depicts an alternate embodiment 110 which comprises a flexible member 130 and an integrated member 120 which is formed into wall 145 of a vessel (not shown). Integrated member 120 could somewhat resemble a punt of a wine bottle if the punt were to have steep sides and an orifice. One having skill in the art would recognize that there are numerous ways of integrating such a member in a vessel wall and the particular shape and size of the member to be implemented.

Integrated member 120 is sheathed by a flexible member 130 and comprises a channel 125 that allows flow therethrough. Flexible member 130 comprises an aperture (see aperture 35 of FIG. 3) through which flow may pass. The aperture (not shown) of flexible member 130 forms the outlet port 170. Rotating the vessel past or below a horizontal axis causes air to be drawn into valve 110 via inlet port 160 and out of valve 110 via channel 125 and outlet port 170, shown open.

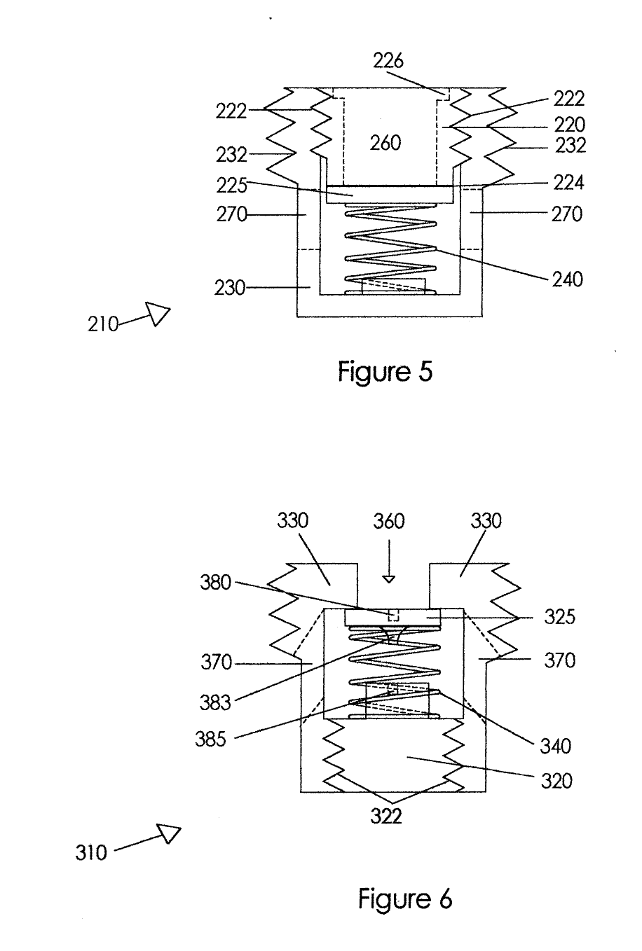

FIG. 5 depicts an alternate embodiment of the disclosed device wherein the valve comprises an assembly having a plate 225 and a compressible spring 240. It is contemplated that valve embodiment 210 could be employed in situations involving higher pressures like in the case of carbonated fluids. Valve 210 is removable from the vessel wall if desired and can be saved for later reuse.

Valve 210 comprises a core 220 and a housing 230 having external threads 232 to enable the mounting of the device into (and its removal from) an appropriate orifice in a vessel wall (not shown). Housing 230 further comprises longitudinal wall slots 270 which serve as outlet ports. The open tube of core 220 forms the inlet port 260.

Core 220 is adapted to be received by housing 230 and may be secured thereto by means of threads 222. In other words, core 220 is insertable in an open end of housing 230 whereby the core and the housing can be adjusted in relation one with the other. Core 220 can travel inwardly or outwardly which thereby causes plate 225 to respectively travel inwardly or outwardly. Spring 240 is shown mounted in housing 230 and secured therein by plate 225 and an end 224 of core 220. As shown, plate 225 serves to cover or close the inlet port 260. Valve 210 is a normally closed valve. The tension on spring 240 is adjusted by rotating core 220 in threads 222 with a tool (not shown) that engages slot 226 in core 220. Low spring tension results in a very sensitive valve. When used in the same manner as the valve of FIG. 1, rotating the vessel past or below a horizontal axis activates the valve.

While this valve can be used in the same manner as the valve of FIG. 1, the primary applications envisioned are in containers which are too heavy to be easily rotated beyond the horizontal such as, but not limited to, beer kegs, fuel and oil barrels, and other larger containers. Such containers already contain an exit, i.e., valve or other exit control, and periodic content removal is the common practice. The devices disclosed herein allow for the smooth discharge of liquid from such container and in the case of a beer keg, can eliminate the need for the use of a keg pump. Valve 210 and valve 310 open whenever liquid is withdrawn from the container and close when the removal of liquid stops.

As referenced above, an operator could utilize a tool in the open tube of core 220 to adjust the tension of spring 240. Alternately, valve 210 could comprise an external mechanism such as lever or knob mounted external to base 220 to facilitate the adjustment of the plate 225 and spring 240.

In the embodiments disclosed here, the springs and plates are composed of brass for that material's strength, resistance to corrosion, appealing appearance, and ability to be easily formed. In addition, the bases, assemblies, and housings are cylindrical. Any suitable material of construction and configuration could be used depending on the particular application and still fall within the scope of the disclosure.

It is recognized that base 220 could protrude past an exterior edge of a vessel to cause undesired vessel rocking. This could also occur as a result of the location of the external lever/knob mechanism described above. Therefore, it may be advantageous to incorporate this embodiment in vessels having an indentation or concave end to reduce vessel instability when it is placed on substantially planar surface such as a table. For example, the device could be utilized in a glass or plastic bottle having a punt or a kick-up. One having ordinary skill in the art would know the degree of the rise and configuration of the bottle base to be utilized to accommodate the addition of the disclosed valve.

FIG. 6 illustrates an alternate embodiment of the disclosed device discussed in FIG. 5. Valve 310 is a normally closed valve that comprises an assembly 320 and a housing 330 having external threads to enable the mounting of the device into (and its removal from) an appropriate orifice in a vessel wall (not shown).

Assembly 320 is mounted in housing 330 and can be secured thereto by means of internal threads 322. Assembly 320 can travel inwardly or outwardly along internal threads 322. Housing 330 further comprises wall slots 370 which serve as outlet ports.

Spring 340 and plate 325 are mounted in assembly 320. Plate 325 is seated against inlet port 360 to prevent flow therethrough. The diameter of port 360 should be sufficiently small so as to retain plate 325 within housing 330.

Plate 325 comprises a male member 383 that is mateable with female member 385. Plate 325 further comprises screw head 380 that can be useful for adjusting valve 310. In use, an operator could insert the tip of a screwdriver into screw head 380 to turn assembly 320. Placing pressure on plate 325 will cause spring 340 to compress so that female member 385 can receive male member 383. Depending on the direction of the turn, assembly 320 may travel inwardly or outwardly. When assembly 320 advances inwardly, tension on spring 340 is increased. A larger pressure differential is thus required before plate 325 is displaced to answer the demand.

One having skill in the art would recognize that in some cases it may be desirable to place the valve's adjustment means on the outlet side of the valve. This type of placement could be useful to prevent tampering with by other than designated individuals. In addition, it is contemplated that some embodiments could be two-way adjustable. In other words, a valve can be adjusted on its inlet side and/or the outlet side.

Though not shown, the disclosed device could comprise closure means that can be used to lock the valve in place in a vessel. This feature of the device could be useful to prevent tampering with or removal of the valve. For example, a safety wire could be threaded through the vessel walls adjacent the inlet ports disclosed herein. When the device is ready to be engaged, the closure means can be removed by snipping the wire to allow access to the valve. One having skill in the art, however, would recognize that any suitable closure means could be employed to facilitate safety and secure transport of valve installed in a liquid-containing vessel and to disallow removal or theft of the valve. In addition, the safety wire could be crimped or otherwise reinforced.

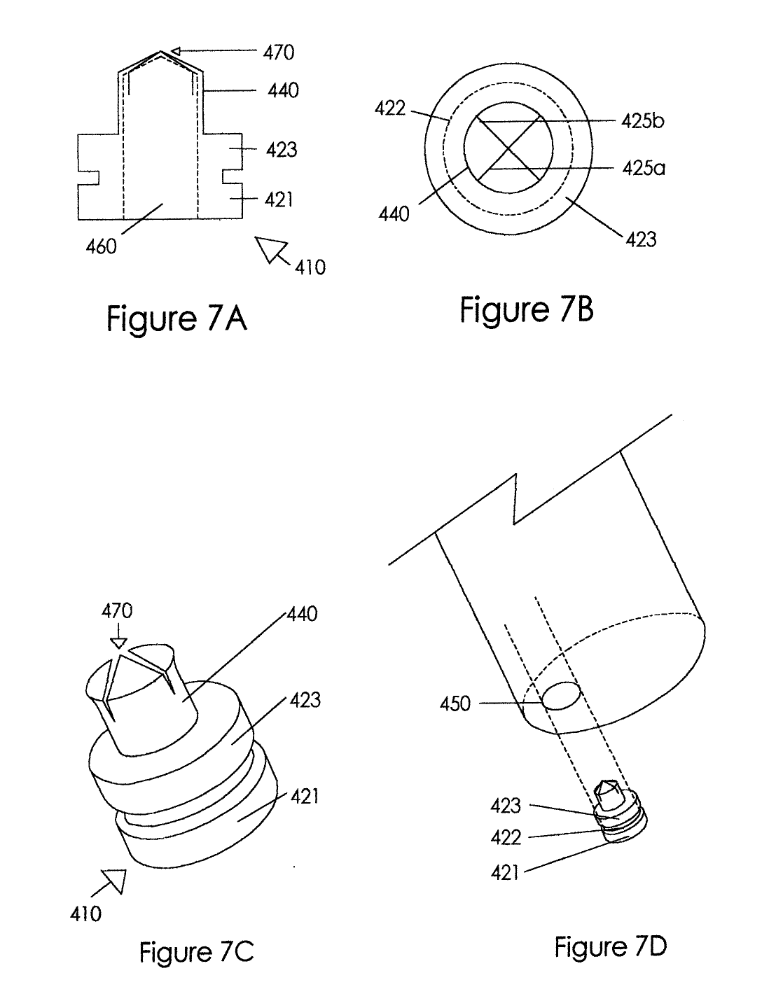

FIGS. 7A and 7B depict an alternate embodiment of the disclosed device at rest in a normally closed position. FIG. 7C depicts the device in an open position. Valve 410 is substantially flexible and may be installed in an orifice in a wall of a container or vessel. Valve 410 comprises a pair of flanges 421, 423 adjacent an inlet port 460. End member 440 comprises an outlet port 470. As shown in FIG. 7D, the disclosed device can be mounted such that a wall edge 450 of a container that is adjacent an orifice is seated in groove 422 between the pair of flanges 421, 423. End member 440 comprises perpendicular slots 425a, 425b capable of forming an aperture that may be opened or closed (see also FIG. 7B).

One having skill in the art would recognize, however, that the valve could be installed in t an appropriate side wall at the lower end of the container. In addition, one having skill in the art would recognize that a covering means could be employed to facilitate safety and secure transport of a valve installed in a liquid-containing vessel. For example, a security seal could be placed over the inlet side of the valve to protect the valve and/or to disallow removal, tampering, or theft of the valve.

In another contemplation of the disclosed device, the portion of the valve which comprises flanges 421, 423 could be located distally from end member 440. The two portions could then be connected together by means of a substantially rigid tube member. This variation of the disclosed device could be installed in a vessel such as a soda can (not shown). Assuming an orifice was to be placed in the top wall of a soda can, e.g., directly behind the can's pop-top, flange 421 would rest above the top of the can while flange 423 is positioned below the surface of the can. Although not shown, the tube member and end member 440 would extend into the can.

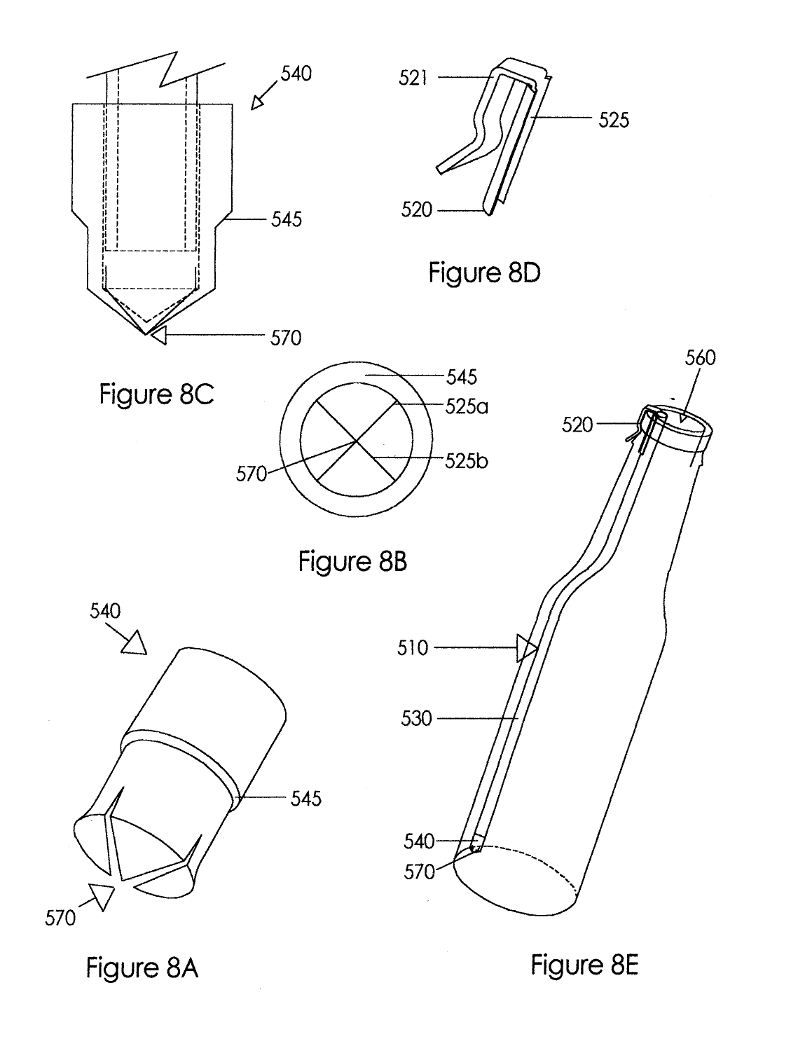

FIGS. 8A to 8E depict another embodiment of the disclosed device. Referring now to FIG. 8E, it can be seen that valve 510 comprises an end member 540, a tube member 530, and an attaching member 520. End member 540 is similar to end member 440 and is installable on an end of tube member 530 as shown. End member 540 comprises an outlet port 570 and perpendicular slots 525a, 525b capable of forming an aperture. See also FIGS. 8A-8C.

Attaching member 520 is installable on an opposite end of tube member 530. See FIG. 8D. A clip or hook 521 facilitates the mounting of valve 510 in a container's open end 560. Clasp or clamp 525 is useful for fastening attaching member 520 to an upper end of tube member 530. Hook 521 and clamp 525 are formed of brass though one having ordinary skill in the art would recognize that the means of fastening the valve 510 to a container and that of fastening the connecting member would depend on the application. If the positioning of a clip or mechanical fastener would impede the operation or placement of the container's cap (or lid), a less obtrusive attachment means such as an adhesive could be employed.

In this embodiment, tube member 530 can be rigid or flexible. For example, a conventional plastic straw could be used. In one contemplation, a food-safe adhesive could be used to fasten an end of a bendable plastic straw to the inside lip of a glass bottle.

One having skill in the art would recognize that these embodiments could take the form of a retrofit valve installable in a container such as a soda can, a soup can, glass or plastic bottle, etc. whereupon the valve could be removed after use and saved for later reuse. Alternately, this embodiment could take the form of a permanently mounted valve if so justified by the application. For example, a permanent-mount valve could be useful in the case of vessels containing hazardous materials. One having skill in the art would recognize that a sealing means could also be employed to facilitate safety and secure transport of a valve installed in a liquid-containing vessel. A security foil or seal could be placed over a container orifice designated to accept the insertion of the valve.

It should be evident that this embodiment has relation to containers that are common in daily residential and household uses. As stated above, the materials of construction, e.g., plastic, metal, etc. should meet requirements set by the FDA for food-grade packaging. It is also contemplated that the disclosed device could be used for vessels in industrial, commercial, and agricultural settings or anywhere where there is a need for more effective discharge of liquids. One having ordinary skill in the art would recognize that the materials of construction would thus be chosen accordingly.

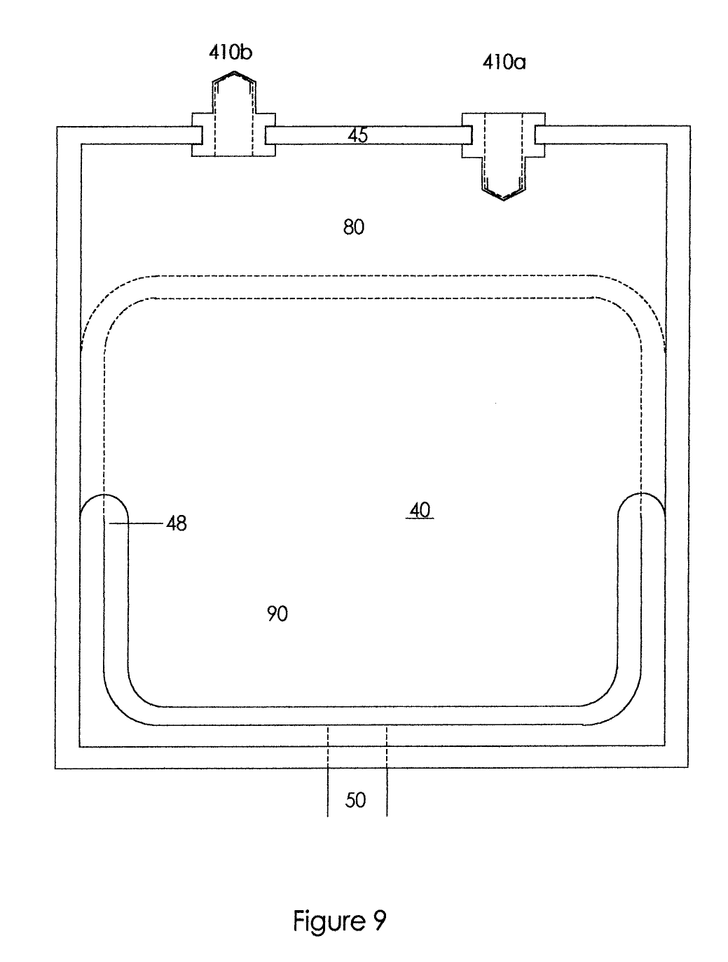

FIG. 9 depicts the disclosed device adaptable for use in an industrial application. Valves 410a, 410b are shown positioned in wall 45 of a tank vessel 40 having an industrial liner 48. As fluids are received in vessel 40, they are encapsulated in liner 48 which unfurls and expands upwardly toward the vessel's upper end. As fluids are emptied from vessel 40, liner 48 can collapse. The volume of air space 80 would thus increase or decrease depending on the volume of fluid in vessel 40 and the compression or expansion of liner 48. Valves 410b, 410b are similar to the valve set forth FIGS. 7A-7C. In this depiction, valve 410b can serve as a relief valve useful to relieve pressure in the vessel caused by the volume of fluid in vessel 40 and the nature of the liner's contents.

This embodiment of the disclosed device has relation to industrial tanks or vessels. Therefore, one having ordinary skill in the art would recognize that the materials of construction of the valve should meet suitable requirements set by the industry in which it will be applied.

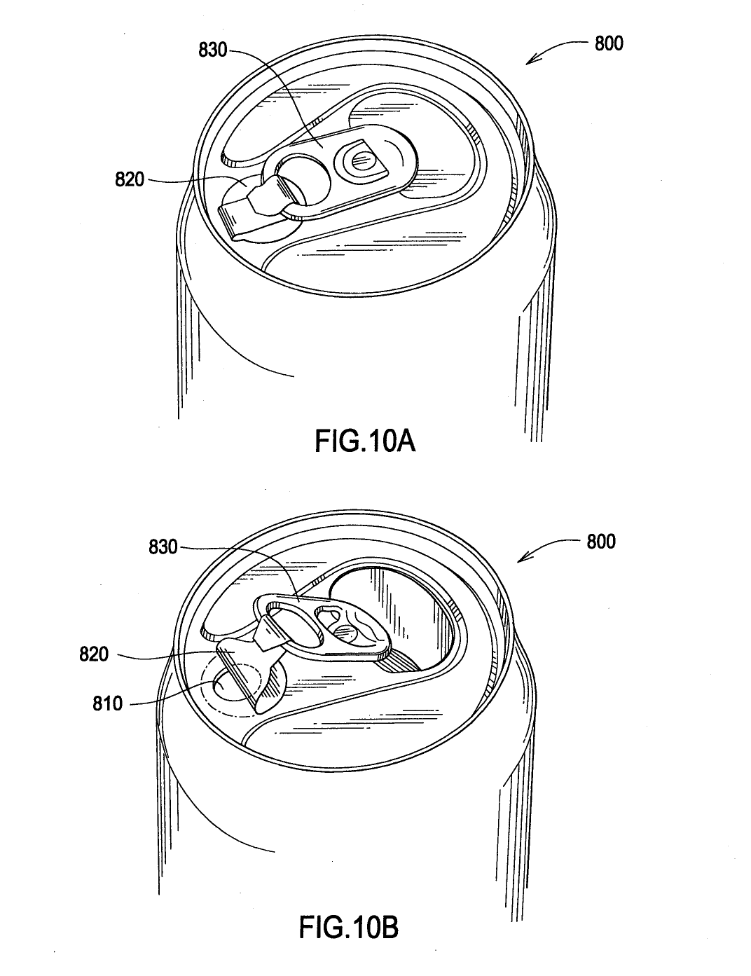

FIGS. 10A, 10B depict an embodiment 800 comprising a conventional pull tab 830 and a sealing means 820. FIG. 10A depicts valve 810 in a closed mode; FIG. 10B depicts valve 810 in an open and activated mode. As pull tab 810 is lifted, sealing means is also lifted to uncover valve 810. Sealing means 820 can be made of food-grade materials such as those used in juice packaging, for example.

Although the disclosed device and method have been described with reference to disclosed embodiments, numerous modifications and variations can be made and still the result will come within the scope of the disclosure. No limitation with respect to the specific embodiments disclosed herein is intended or should be inferred.

I claim:

1. A valve to enable a smooth discharge of fluid from a container, the apparatus comprising:
a small diametered hollow vent having an assembly to allow air to directly enter a head space in said container;
said vent being openable to allow air passage through an inlet and an outlet when demand is placed thereon; and
said vent being closable when said demand is alleviated.

2. The apparatus of claim 1, wherein said valve is installable in a wall of a container.

3. The apparatus of claim 2, wherein said demand is caused by a canting of said container at a normal pouring angle.

4. The apparatus of claim 3, wherein said demand is alleviated by a rotating of said container above a horizontal axis.

5. The apparatus of claim 1, wherein said assembly further comprises a flexible member.

6. The apparatus of claim 1, wherein said assembly comprises an adjustable spring mounted in a housing and securable therein by means of a plate and a core.

7. The apparatus of claim 6, wherein said spring is adjustable by rotating said core inwardly and outwardly in said housing.

8. The apparatus of claim 7, wherein said core comprises a lever or knob to facilitate its rotation with respect to said housing.

9. The apparatus of claim 1, wherein said valve further comprises external threads to facilitate installation in a wall of a container.

10. The apparatus of claim 1, wherein said assembly comprises an adjustable spring and a pair of plates, said assembly mounted in a housing.

11. The apparatus of claim 10, wherein a first of said plates comprises a male member mateable with a female member on a second of said plates to enable an adjustment of said spring.

12. The apparatus of claim 1, wherein said assembly further comprises a tube member extendable into said head space and an attachment member to facilitate the mounting of said valve to a wall of a container.

13. The apparatus of claim 2, wherein said demand is caused by creating a pressure differential at said inlet and an outlet whereby fluid flows from a high pressure region to a low pressure region.

14. In conjunction with a container or vessel, an apparatus enabling a smooth discharge of fluid therefrom, said apparatus comprising:
a valve installable in a wall of said container or vessel;
said valve having an assembly to allow air to directly enter a head space in said container or vessel;
said valve being openable to allow air passage through an inlet and an outlet when demand is placed thereon; and
said valve being closable when said demand is alleviated.

15. The apparatus of claim 14, wherein said assembly further comprises a substantially rigid member sheathed by a flexible member.

16. The apparatus of claim 15, wherein said substantially rigid member is integrally formed as a part of said container wall.

17. The apparatus of claim 14, wherein said assembly further comprises an adjustable spring.

18. The apparatus of claim 14, wherein said assembly further comprises a substantially flexible member having a pair of flanges to support a mounting of said member in said container or vessel wall.

19. A container to enable a smooth discharge of fluid therefrom, said container comprising:
a means for opening said container;
a valve positioned in a top wall of said container and covered by a seal;
wherein an opening of said container by said means causes a removal of said seal covering said valve;
said valve capable of allowing air to directly enter a head space in said container when demand is placed thereon, said demand being caused by a canting of said container at a normal pouring angle; and
wherein said demand is alleviated by a rotating of said container above a horizontal axis.

20. The container of claim 19, wherein said valve is a hole or an orifice.
